(19) United States
(12) Patent Application Publication
(10) Pub. No.: US 2019/0167035 A1
(43) Pub. Date: Jun. 6, 2019

(54) DOUBLE ROTATING PORTABLE BARBECUE GRILL

(71) Applicant: Vector Industria de Produtos Metalurgicos Ltda, Caxias do Sul (BR)

(72) Inventor: Eliane Luisa Stocker, Caxias do Sul (BR)

(73) Assignee: Vector Industria de Produtos Metalurgicos Ltda, Caxias do Sul (BR)

(21) Appl. No.: 15/923,000

(22) Filed: Mar. 16, 2018

(30) Foreign Application Priority Data
Dec. 5, 2017 (BR) 10 2017 026232

(51) Int. Cl. A47J 37/04; A47J 37/07

(52) U.S. Cl. CPC A47J 37/041; A47J 37/0763

(57) ABSTRACT

“Double rotating portable barbecue grill”, as described in the report, refers to a new, portable, superimposed, rotating barbecue grill with gas tubular burners and/or electric resistance type burners, allowing bilateral access to the skewers and unique control mechanisms laterally arranged. The tubular burners have lateral heat distribution to reach the two vertical rows of skewers, enabling the programming of the temperature and control of the skewers' rotation.

### SUBJECT

The present invention relates to a new, portable, superimposed, rotating barbecue grill with gas type tubular burners and/or electric resistance type burners, allowing bilateral access to the skewers, and unique control mechanisms arranged laterally. The tubular burners have lateral heat distribution to reach the two vertical rows of skewers, enabling the programming of the temperature and control of the skewers' rotation.

### STATE OF THE ART

The state of the art, which is the subject of the present improved construction, is known from BR.202016022897-8, filed on Sep. 30, 2016, entitled “Constructive Arrangement in Double Rotating Portable Barbecue grill”, which features a barbecue grill with double side access and two vertical lines of skewers, endowed with a central line of shielded electrical resistances.

As a usage problem, we observe that the individual controls of the temperature and skewers' rotation are separated on each side. That is, there are individual controls on both sides of the barbecue grill, next to each access door of the skewers. This construction requires from the parameters constant movement of the user from side to side and requests adjustment errors when it occurs on one side only, turning handling difficult and compromising the final result. In addition, double controls increase costs and need of maintenance.

Although this previous document comments on the possibility of replacing the electrical resistances by tubular burners, its construction is not determined on the document.

The document BR202016016789-8, also from the same applicant, deposited on Jul. 20, 2016, entitled “Constructive Arrangement in Barbecue grill with Tubular Burner”, describes the existence of two tubular burners for gas use, with square section with two lines of upper holes for flame exit. A diffuser, superior to the flames, is fixed on the barbecue grill's box and has the function of spreading the heat and protecting the burner.

As a problem of this constructive form, we verified that the tubular burner of square section with upper holes concentrates the heat in its upper part, requiring the reach of high internal temperature, so that the diffusion of heat throughout the inside of the device takes place on a uniform way. Situations of high internal temperature are not always ideal depending on the food being prepared.

The application of this tubular burner, familiar to double barbecue grills, containing two rows of skewers on the side of the burners and arranged in the center line, was not adequate due to the fact that it did not provide the heat diffusion bilaterally in order to uniformly heat the two parallel lines of skewers.

Therefore, the technique does not contemplate barbecue grills with double access and double row of skewers with central burners, especially tubular ones for gas use, with a single control panel lateral to the device.

### INVENTIVE CONCEPT

The present Double Rotating Portable Barbecue grill proposes the solution of technical problems in currently known models.

In order to do so, the present object was developed from the difficulties observed on previous models, mainly regarding the efficiency of the tubular burners, adding the double access barbecue grill and central tubular burners that diffuse the heat bilaterally, allowing better final results to the user.

In order to achieve this, the tubular burners have a circular section arranged laterally, with lines of holes for diffusion of the flames, with upper diffusers fixed directly on the burners themselves. This constructive form makes the heat to diffuse uniformly on both sides of the burner, reaching both rows of skewers, even at lower temperatures. It is therefore suitable for the preparation of various types of food.

It is also worth noting that the construction of the equipment, regarding control and programming buttons, arranged laterally to the equipment, allows better use and greater comfort to the user, besides the reduction of costs for manufacturing. We understand that the two sides being controlled by buttons grouped in a unique way avoids unwanted programming differences and provides greater ease of adjustments, guaranteeing better results in the end.

The use of a central line of shielded electric resistances in case of electric functioning is planned.

### APPLICATION FIELD

The application of the present Double Rotating Portable Barbecue grill is given as an appliance and rotisserie for commercial use.

### BENEFITS

The present proposal for a new Double Rotating Portable Barbecue grill has as advantages:
Better efficiency in the diffusion of heat by tubular burners, allowing even preparation of food at any temperature;
Possibility of single lateral access to the control buttons, allowing better conditions of regulation and programming, besides the possibility of access to the foods from both sides, turning the skewers easier to handle;
Possibility of preparing twice the food in a barbecue grill with usual dimensions, portable, superimposed, suitable for residences, through the double line of skewers;
Possibility to use it stacked, on a benchtop, allowing it to be positioned in the best way by the user;
Energy saving due to reduction of food preparation time, avoiding waste of the heat generated on the burners;
Better cost-benefit ratio to the user, since it has greater capacity to prepare food in a small equipment;
As a device with single control and programming central laterally arranged, the costs and industrial processes were reduced;
Manufacturing flexibility, due to the possibility of using tubular, infrared or shielded resistances burners, which allows the manufacture of several models of equipment; including variation in the number of skewers;
Manufacturing flexibility, as it may contain mechanisms for electric or gas use;
Ease of handling and cleaning;
Allows less use of spaces in kitchens, with high yield of food preparation, which is important in residences with reduced spaces;
Great aesthetic final quality, provided by the compact construction format equipped with two glass doors;
Allows several options of external finishing of the barbecue grill, such as stainless steel brushed, polished, satin or painted in epoxy in varied colors;
Allows several options of external finishing of the tubular burners, such as stainless steel enamel, satin or painted in epoxy in varied colors.

### ILLUSTRATIONS

In order to facilitate the research and provide understanding of the present invention, as set forth in the report, according to a basic and preferred embodiment developed by the applicant, reference is made to the attached illustrations which form part of and support this descriptive report, wherein:

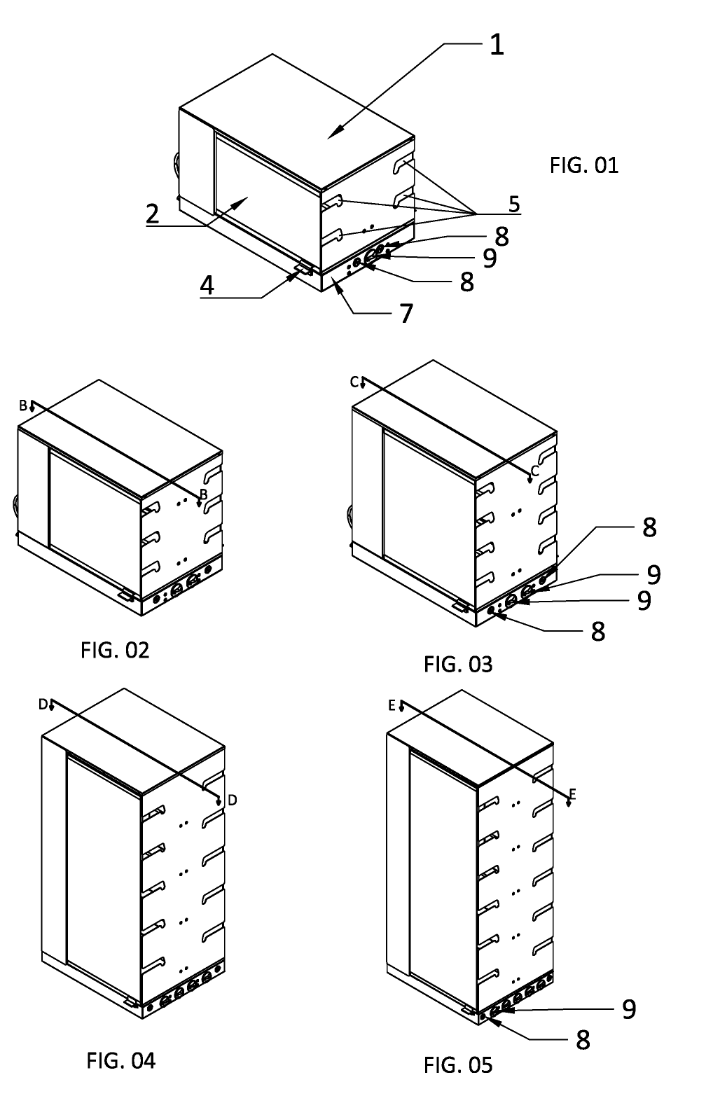

FIG. 01—presents the front perspective of the barbecue grill for 4 skewers;

FIG. 02—presents the front perspective of the barbecue grill for 6 skewers;

FIG. 03—presents the front perspective of the barbecue grill for 8 skewers;

FIG. 04—presents the front perspective of the barbecue grill for 10 skewers;

FIG. 05—presents the front perspective of the barbecue grill for 12 skewers;

FIG. 06—presents the rear view of the barbecue grill;

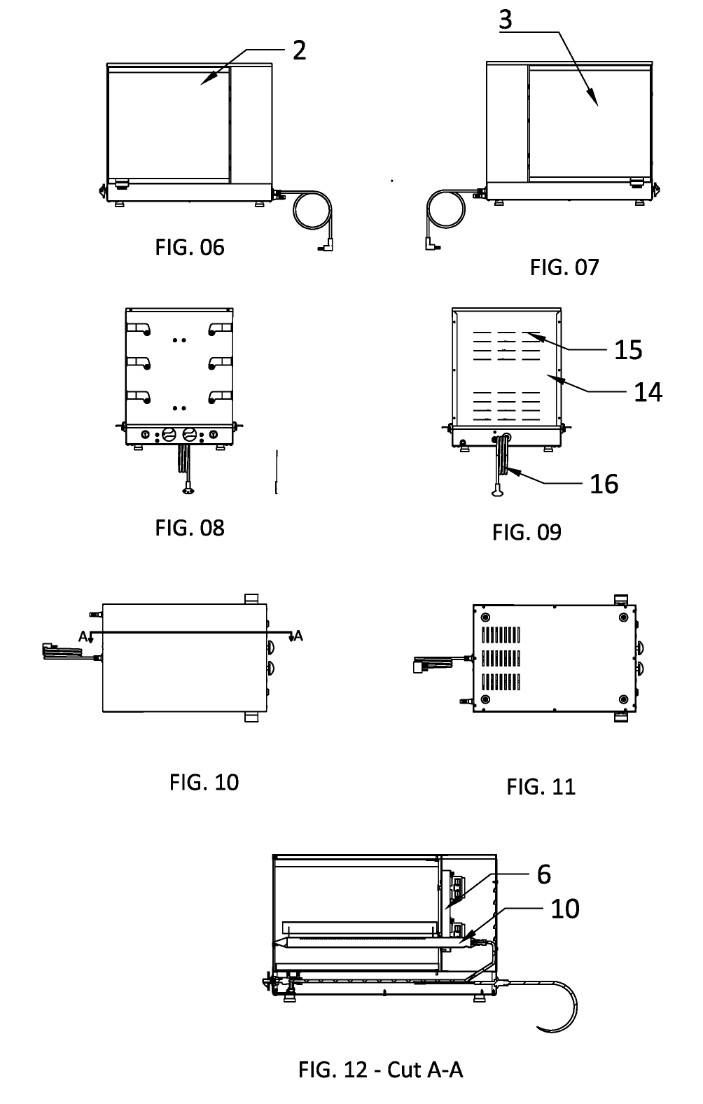

FIG. 07—presents the front view of the barbecue grill;

FIG. 08—presents the right lateral view of the barbecue grill for 4 skewers;

FIG. 09—presents the left lateral view of the barbecue grill for 4 skewers;

FIG. 10—presents the top view of the barbecue;

FIG. 11—presents the bottom view of the barbecue;

FIG. 12—presents the Cut A-A in the gas version;

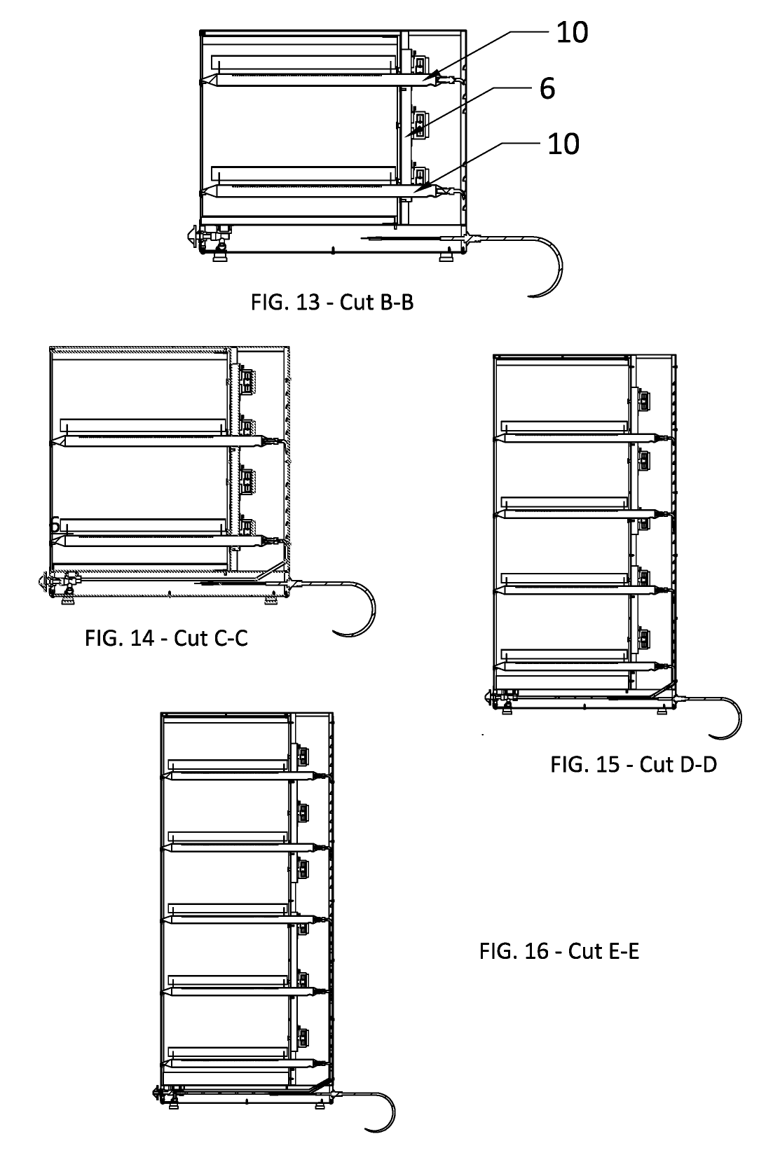

FIG. 13—presents the Cut B-B in the gas version;

FIG. 14—presents the Cut C-C in the gas version;

FIG. 15—presents the Cut D-D in the gas version;

FIG. 16—presents the Cut E-E in the gas version;

FIG. 17—presents the exploded perspective of the barbecue grill in the gas version;

FIG. 18—presents the perspective of the tubular burner with diffuser;

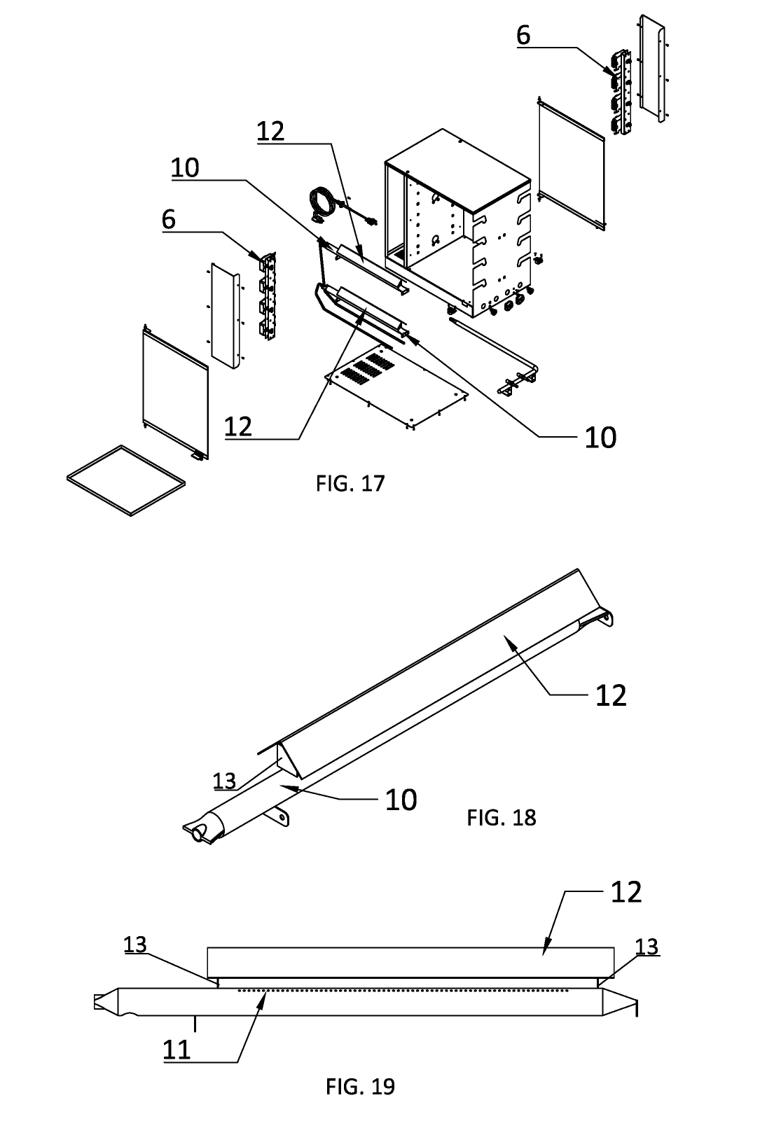

FIG. 19—presents the front view of the tubular burner with diffuser;

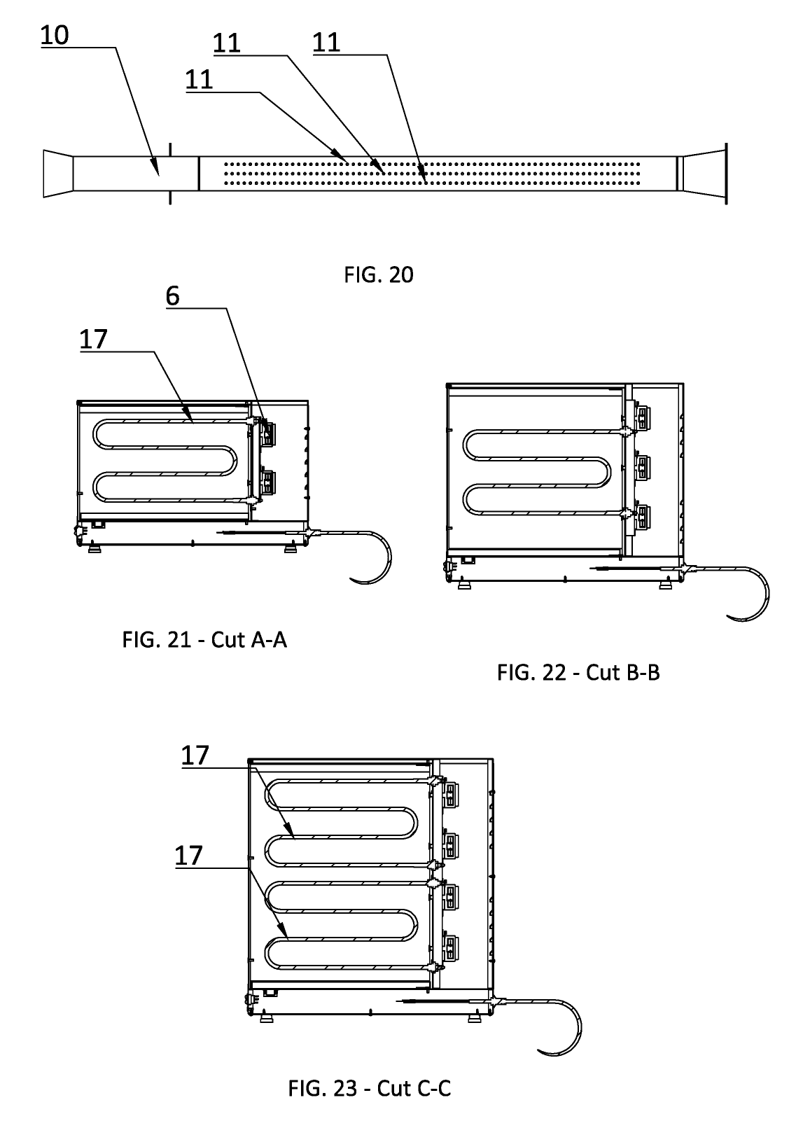

FIG. 20—presents the top view of the tubular burner without diffuser;

FIG. 21—presents the Cut A-A in the electric version;

FIG. 22—presents the Cut B-B in the electric version;

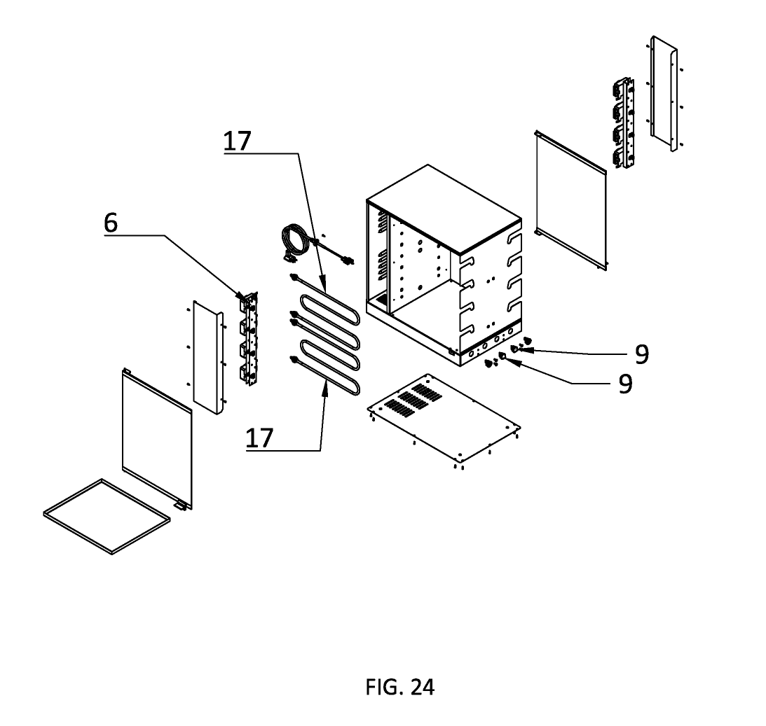

FIG. 23—presents the Cut C-C in the electric version;

FIG. 24—presents the exploded perspective of the barbecue grill in the electric version.

### DESCRIPTION

As we observe from the figures presented, the Double Rotating Portable Barbecue Grill has versions with 4, 6, 8, 10 and 12 skewers, and only in versions with 4, 6 and 8 skewers there is electric resistance burner option.

Thus, the object of the present invention is composed of the external case (1) endowed with tilting covers (2) and (3), on both sides, generally in glass, individually handled. The tilting covers (2) and (3) have a handle (4).

The external case (1) has on one of its side oblong holes (5) suitable for supporting the skewers, which are also engaged in the couplings of the micromotors (6), responsible for their rotational movement.

The actioning of said micromotors (6) is carried out in the lateral control central (7) arranged at the bottom and laterally to the barbecue grill, containing the rotating selectors (8), which allow to turn on and off the rotation movement of the two lines, individually, and the heating selectors, (9) in which the activation of the tubular burners (10) is determined.

The version of the barbecue grill with 4 skewers has two vertical lines of 2 skewers each, with a single internal burner (10), driven by the single heating selector (9). The versions of the barbecue grill with 6 and 8 skewers have two vertical rows of 3 and 4 skewers each, respectively, with two internal tubular burners (10), driven by the heating selectors (9). The versions of the barbecue grill with 10 and 12 skewers have two vertical lines of 5 and 6 skewers respectively, each with four and five internal burners (10), respectively, driven by the heating selectors (9).

The tubular burner (10) has a circular section containing three lines of orifices (11) arranged laterally for propagation of the flames. The diffuser (12) may be welded or fitted to the burner by the steel sheet (13).

The lateral closure (14) of the external case (1) contains holes (15) for internal ventilation, where the electric harness for connecting the electric power cable (16) is added.

The variation of the barbecue grill with electric operation occurs through electric shielded resistances (17), and the barbecue grill version with 4 skewers has two vertical lines of 2 skewers each, with a single internal electric resistance shielded (17), activated by the selector heating switch (9). The versions of the barbecue grill with 6 and 8 skewers have two vertical rows of 3 and 4 skewers each, respectively, with two internal electric shielded resistors (17), driven by the heating selectors (9).

### CONCLUSION

In this way, the Double Rotating Portable Barbecue Grill is subsidized by unpublished technical and functional characteristics, as can be seen in the attached figures and understood in the descriptive report, thus deserving the legal protection sought.

1. Double rotating portable barbecue grill comprising
an external case, (1) having a door mounted on each of two opposite faces of the case, said case being further provided with two sets of lateral holes (5) for supporting skewers connected to micromotors (6), the holes being located one above the other and being disposed in at least one of the faces other than those on which the doors are mounted;
said case further comprising a lateral closure (14) provided with vents (15) and an electric power cable (16),
wherein the external case (1) is provided with central lateral control (7), arranged on the back and on the side of the barbecue grill, said control including rotation selectors (8) for individual control of skewers located in said sets of holes, and the heating selectors (9) that control gas-operated tubular burners (10) having a circular section with three lines of orifices (11), disposed laterally, and a diffuser (12) mounted above said burner.

2. Double rotating portable barbecue grill as claimed in claim 1, wherein said sets of lateral holes comprise two vertical rows for supporting 2 skewers each, with a single internal tubular burner (10), individually controlled by the single heating selector (9).

3. Double rotating portable barbecue grill as claimed in claim 1, wherein said sets of lateral holes comprise two vertical rows for supporting 3 or 4 skewers each, with two inside tubular burners (10), individually controlled by the heating selectors (9).

4. Double rotating portable barbecue grill as claimed in claim 1, wherein said sets of lateral holes comprise two vertical rows for supporting 5 or 6 skewers each, with four or five internal tubular burners (10), respectively, individually controlled by the heating selectors (9).

5. Double rotating portable barbecue grill comprising
an external case, (1) having a door mounted on each of two opposite faces of the case, said case being further provided with two sets of lateral holes (5) for supporting skewers connected to micromotors (6), the holes being located one above the other and being disposed in at least one of the faces other than those on which the doors are mounted;
said case further comprising a lateral closure (14) provided with vents (15) and an electric power cable (16),
wherein the external case (1) is provided with central lateral control (7), arranged on the back and on the side of the barbecue grill, said control including rotation selectors (8) for individual control of skewers located in said sets of holes, and the heating selectors (9) that control at least one shielded electric resistance (17) individually.

6. Double rotating portable barbecue grill as claimed in claim 5 wherein said sets of lateral holes comprise two vertical rows for supporting 2 skewers each, with a single internal shielded electric resistance individually controlled by the heating selector (9) that controls each shielded electric resistance (17).

7. Double rotating portable barbecue grill as claimed in claim 5, wherein said sets of lateral holes comprise two vertical rows for supporting 3 or 4 skewers each, with internal shielded electric resistance individually controlled by the heating selector (9) that controls each shielded electric resistance (17).
